(19) United States
(12) Patent Application Publication
(10) Pub. No.: US 2010/0182384 A1
(43) Pub. Date: Jul. 22, 2010

(54) Automatic ink supply device of inkjet printing machine

(76) Inventor: Jia-Hong Cheng, Nanhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,149

(22) Filed: Jan. 21, 2009

(51) Int. Cl. B41J 2/175

(52) U.S. Cl. 347/86

(57) ABSTRACT

An automatic ink supply device of inkjet printing machines is revealed. A float switch for control of a blower is disposed in an ink cartridge of an inkjet printing machine. The ink cartridge is connected to an ink bottle by an ink line while the ventilation is also connected with the ink bottle by a blast pipe. When the amount of pigment ink in the ink cartridge of the inkjet printing machine is below a preset value, a float member of the float switch falls so as to turn on the blower for blowing air into the ink bottle. By air pressure, the pigment ink in the ink bottle is pressed into the ink cartridge until the pigment ink in the ink cartridge increases to the preset amount. Then the float member of the float switch is also pushed to rise so as to turn off the blower and no more air is input into the ink bottle. Thereby, the refilling of the pigment ink is more convenient and the surroundings will not become dirty and messy. The operation efficiency of the machine is also improved.

### BACKGROUND OF THE INVENTION

1. Field of Invention

The present invention relates to an automatic ink supply device of inkjet printing machines, especially to an automatic ink supply device that supplies various colors of pigment ink to inkjet printing machines automatically and continuously. By the automatic ink supply, the refilling of the pigment ink is more convenient and the surroundings will not be messed due to dropping of the pigment ink. Moreover, the inkjet printing efficiency is improved and the practical value of the automatic ink supply device is increased.

2. Brief Description of the Prior Art

With the rapid development of computer technology, various automatic machines and equipment controlled by computer commands are used broadly in our daily lives. One of them is the large inkjet printing machine. In the everyday lives, there are a plurality of advertisings, signs, and billboards in our surroundings. The figures or words on these advertisements, signs, or billboards are painted manually in early days. Considering cost of labors, operation speed, and working quality, manual printing is gradually replaced by inkjet printing of machines.

The large inkjet printing machine includes a plurality of ink cartridges with various colors of pigment ink disposed thereon and each of the ink cartridges is connected with a print head on the machine. Under the control of computer command, the print heads on the machine move along with print lines of desired figures and words and eject ink with required colors at certain positions. Thus printing of large-scale images is done with reduced cost, less time, higher operation efficiency and better working quality.

However, the large inkjet printing machine still has some problems in practice although it has advantages of capability of printing large-scale images, reduced cost, time-saving, higher operation efficiency and better operation quality. When the pigment ink in the ink cartridge has run out, the ink cartridge is dispatched and replaced. The empty ink cartridges cause environmental pollution and waste of resources. While replacing the ink cartridge, the inkjet printing machine needs to be shut down, together with inconvenience in the ink cartridge replacement, the working efficiency is reduced. Although refill pigment ink now is available on the market, special tools are required to fill the pigment ink into the ink cartridge through an injection hole thereof. During the refilling processes, the pigment inks may drop outside the ink cartridge and leave a mess in surrounding areas. Thus there is a need to improve refilling of the pigment ink and replacement of the ink cartridge of the large inkjet printing machines.

### SUMMARY OF THE INVENTION

Therefore it is a primary object of the present invention to provide an automatic ink supply device of inkjet printing machines that includes a float switch disposed in an ink cartridge of an inkjet printing machine. The float switch controls turning on/off of a blower. The ink cartridge is connected to an ink bottle by an ink line while the blower is connected with the ink bottle by a blast pipe. When the amount of pigment ink in the ink cartridge of the inkjet printing machine is below a preset value, a float member of the float switch falls so as to turn on the blower for sending air into the ink bottle. By air pressure, the pigment ink in the ink bottle is pressed into the ink cartridge until the pigment ink in the ink cartridge increases to the preset amount. Then the float member of the float switch is also pushed to rise so as to turn off the blower and no more air is input into the ink bottle. Thereby, the refilling of the pigment ink is more convenient and the surroundings will not be messed. Furthermore, the inkjet printing efficiency is improved and the practical value of the automatic ink supply device is enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment of an inkjet printing machine according to the present invention;

FIG. 2 is a partial cross-sectional view of an embodiment according to the present invention;

FIG. 3 is a schematic drawing showing ink refilling of the present invention;

FIG. 4 is a schematic drawing showing a stop of ink refilling of the present invention.

### DETAILED DESCRIPTION OF THE PREFERRED EMBODIMENT

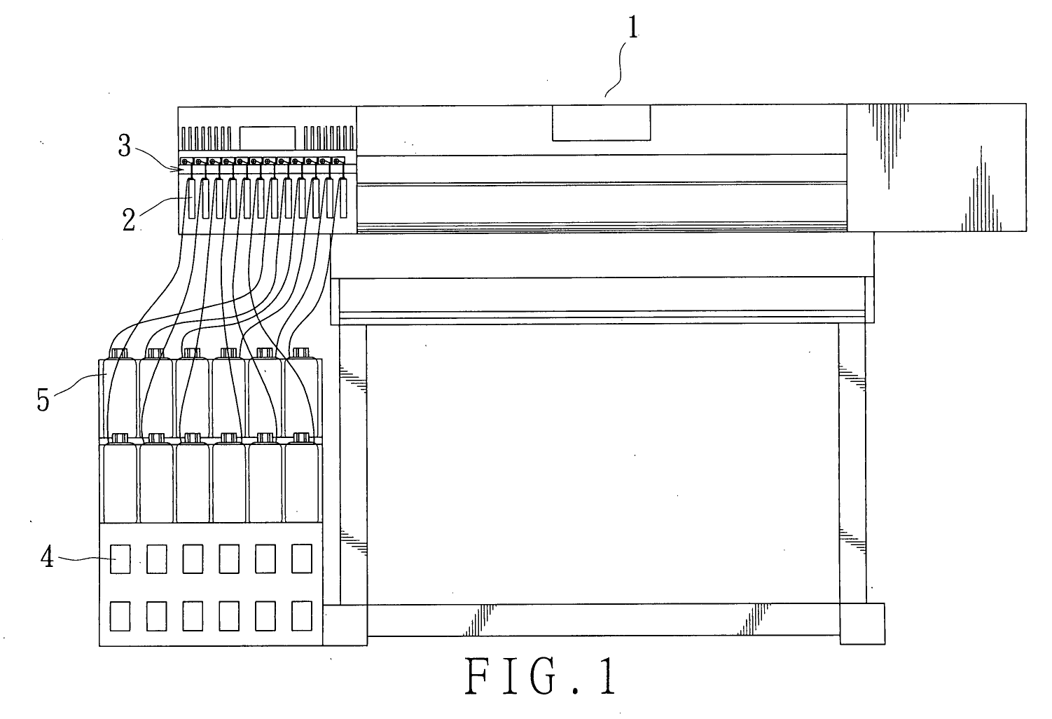

Referring FIG. 1, an inkjet printing machine (1) of the present invention is disposed with a plurality of ink cartridges (2) with various colors of pigment ink therein. Each of the ink cartridges (2) is connected to a print head (not shown in figure) of the inkjet printing machine (1) so as to eject pigment ink with the required colors that form an image.

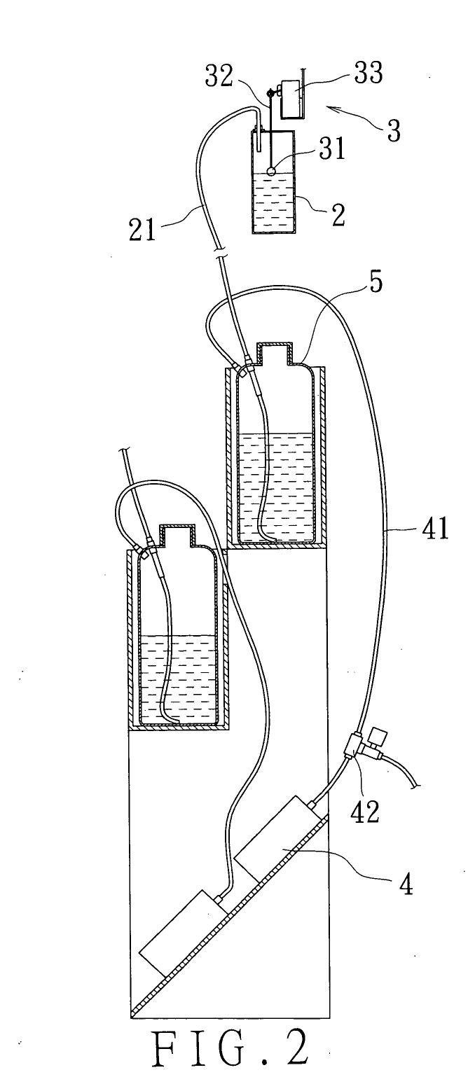

Also referring to FIG. 2, a partial cross sectional view of the embodiment is revealed. A float switch (3) connected with a blower (4) is arranged in the ink cartridge (2) for turning on/off of the blower (4). The ink cartridge (2) is connected to a corresponding ink bottle (5) by an ink line (21) that extends to a bottom of the ink bottle (5). The end of the ink line (21) can be assembled with a filter (not shown in figure). The blower (4) is also to the ink bottle (5) by a blast pipe (41). An electromagnetic valve (42) is set on the blast pipe (41) between the blower (4) and the ink bottle (5) while an end of the blast pipe (41) extends to a top of the ink bottle (5), without contact with the pigment ink therein.

The float switch (3) consists of a float member (31) in the ink cartridge (2), a contact rod (32) on the float member (31) that projects out of the ink cartridge (2) and connects with a switch member (33). When the height (vertical position) of the float member (31) changes, the contact rod (32) is driven to turn on or off the switch member (33).

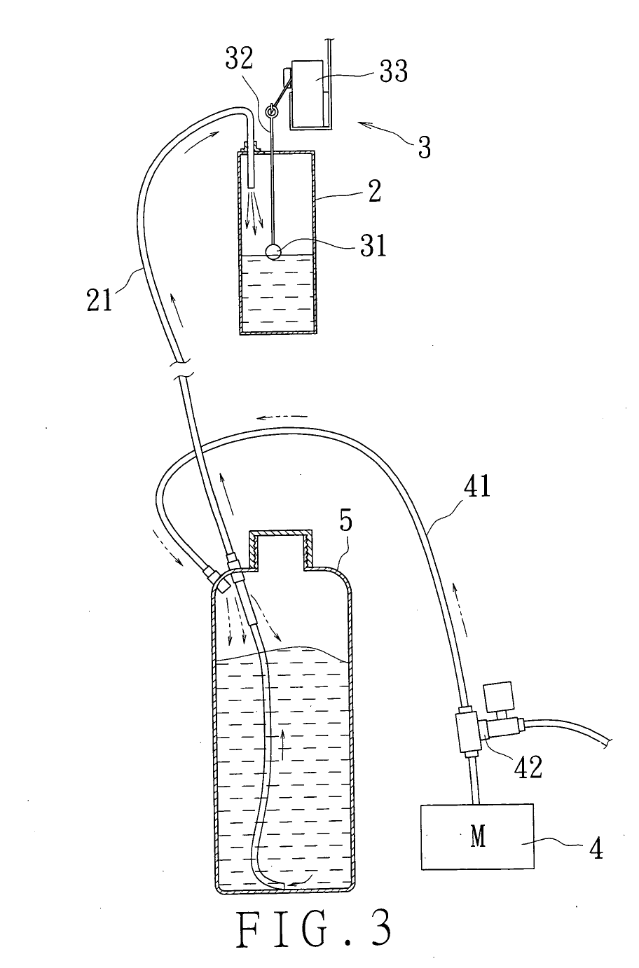

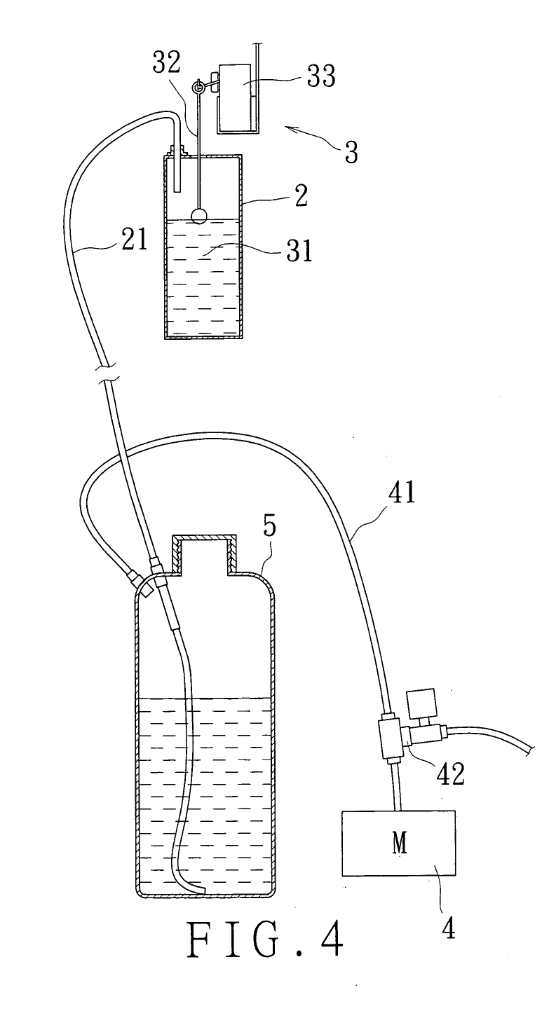

Thereby when the inkjet printing machine (1) works and outputs images by spray of requirements pigment ink from the print heads and the amount of pigment ink in the ink cartridge (2) is below a preset value, the float switch (3) falls along with descending horizontal of the pigment ink in the ink cartridge (2) so as to turn on the blower (4) for input air into the ink bottle (5) through the blast pipe (41), as shown in FIG. 3. Due to change in pressure inside the ink bottle (5), the pigment ink is pressed into the ink cartridge (2) through the ink line (21) and the ink cartridge (2) is refilled. Meanwhile, by means of the electromagnetic valve (42) on the blast pipe (41), the liquid level of the pigment ink inside the ink cartridge (2) is controlled to be stable. Refer to FIG. 4, the refilling process keeps going until the pigment ink in the ink cartridge (2) is refilled to a preset amount, the float switch (3) also rises along with increasing amount of the pigment ink in the ink cartridge (2) so as to turn off the blower (4) and no more air is input into the ink cartridge (2). Thus automatic ink supply is achieved.

In summary, compared with the ink supply system available now, the ink supply device of the present invention includes a float switch disposed in the ink cartridge of the inkjet printing machine. By means of falling or rising of the float switch along with decreasing or increasing of the amount of the pigment ink inside the ink cartridge, the blower is controlled to send or stop sending air into the ink bottle. By pressure of air, the pigment ink in the ink bottle is pressed into the ink cartridge. The device not only facilitates the ink refilling of the inkjet printing machine, but also prevents dropping of the pigment ink that leads to dirty and messy surroundings. Moreover, the printing efficiency of the inkjet printing machine is improved and the practical value of the automatic ink supply device is increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An automatic ink supply device of inkjet printing machines, having ink cartridges with various colors of pigment ink and the ink cartridges connected to print heads of the inkjet printing machines, comprising:
a float switch for control of a blower is disposed in an ink cartridge that is connected to an ink bottle by an ink line and the ink line extends to bottom of the ink bottle while the blower is connected with the ink bottle by a blast pipe and an end of the blast pipe extends to a top of the ink bottle, without contact with the pigment ink therein.

2. The device as claimed in claim 1, wherein the float switch including a float member disposed in the ink cartridge and a contact rod arranged on the float member that projects out of the ink cartridge and connects with a switch member.

3. The device as claimed in claim 1, wherein an end of the ink line connected the ink cartridge is disposed with a filter.

4. The device as claimed in claim 1, wherein an electromagnetic valve is set on the blast pipe between the blower and the ink bottle.
